(19) United States
(12) Patent Application Publication
(10) Pub. No.: US 2022/0132078 A1
(43) Pub. Date: Apr. 28, 2022

(54) SYSTEM AND METHOD FOR USING EVENT CAMERA IMAGE SENSORS FOR OPTICAL COMMUNICATIONS

(71) Applicant: BAE SYSTEMS Information and Electronic Systems Integration Inc., Nashua, NH (US)

(72) Inventors: Daniel ENGHEBEN, Commack, NY (US); Christopher COLICINO, Nesconset, NY (US)

(73) Assignee: BAE SYSTEMS Information and Electronic Systems Integration Inc., Nashua, NH (US)

(21) Appl. No.: 17/076,927

(22) Filed: Oct. 22, 2020

(51) Int. Cl. H04N 7/56; H04N 5/374; H04N 5/378; H04N 5/343

(52) U.S. Cl. CPC H04N 7/56; H04N 5/343; H04N 5/378; H04N 5/374

(57) ABSTRACT

A system for transmitting optical communications includes a transmitter, a receiver, and a processor. The transmitter includes a light source driven by a driver circuit under control of a micro-controller to transmit an optical signal. The optical signal can be encoded by a frequency-modulated encoding scheme. The receiver includes an optical lens, an imaging sensor configured to receive the optical signal and a memory. The processor is configured to extract one or more frequencies from the optical signal for only those pixels that are changing and thus decreases an overall data rate for the system and allows for larger pixel arrays, thereby decreasing the accuracy requirements of any pointing hardware and to reconstruct a waveform for each of the extracted frequencies.

### FIELD OF THE DISCLOSURE

The present disclosure relates to optical communications and more particularly to using event camera image sensors such as dynamic vision sensors for optical communications.

### BACKGROUND OF THE DISCLOSURE

A high bandwidth throughput and an associated high cost is generally necessary for a transmitter and a receiver used for optical communications. For example, a high-speed framing camera requires a very high frame rate in order to act as a communications link, requiring a high processing throughput. Wherefore it is an object of the present disclosure to overcome the above-mentioned shortcomings and drawbacks associated with the conventional camera systems such as a Geiger mode Avalanche Photodiode (APD) cameras or digital ROIC cameras. To mitigate high data rates, prior systems utilize very small pixel arrays which limit receiver field of view and place more burden on the transmitter or receiver pointing gimbals. This system overcomes both problems by only outputting pixels that change, which decreases overall data rate and allows for much larger pixel arrays, thereby decreasing the accuracy requirements of the pointing hardware.

### SUMMARY OF THE DISCLOSURE

A system for transmitting optical communication, comprising a transmitter having a light source driven by a driver circuit under control of a micro-controller to transmit an optical signal, a receiver having an optical lens, an imaging sensor configured to receive the optical signal, a memory, and a processor coupled to the receiver and configured to extract one or more frequencies from the optical signal and to reconstruct a waveform for each of the one or more frequencies extracted from the optical signal.

One aspect of the present disclosure is a system for transmitting optical communication in GPS-denied environments, comprising: at least one transmitter comprising a light source driven by a driver circuit under control of a micro-controller to transmit an encoded optical signal comprising one or more frequencies; a receiver comprising an optical lens, an imaging sensor comprising a plurality of pixels configured to receive the optical signal and provide asynchronous detection among the plurality of pixels for only those pixels having brightness changes in a field of view, and memory; and a processor coupled to the receiver and configured to process the pixels that detect brightness changes and to extract the one or more frequencies from the optical signal, to reconstruct a waveform for each of the one or more frequencies extracted from the optical signal, and to decode the optical signal.

One embodiment of the system is wherein the driver circuit is configured to encode the optical signal by pulse position modulation or pulse width modulation. In certain embodiments, the optical signal is transmitted at a wavelength in the range of 1.55 μm to 1.7 μm for use in covert communication.

Another embodiment of the system is wherein the processor is configured to use the optical signal to perform tracking of the light source. In some cases, the processor is further configured to overlay data received from a complementary metal-oxide-semiconductor (CMOS) array of the receiver with dynamic vision sensor (DVS) data received from the imaging sensor. In certain embodiments, the light source is a light emitting diode (LED).

Yet another embodiment of the system is wherein the use of a dynamic vision sensor or a neuromorphic sensor decreases an overall data rate for the system and allows for larger pixel arrays, thereby decreasing accuracy requirements of pointing hardware.

In certain embodiments, the dynamic vision sensor comprises a read out integrated circuit (ROIC) combined with a photosensitive material. In some cases, the photosensitive material is Indium Gallium Arsenide (InGaAs).

Still yet another embodiment of the system is wherein the optical signal is transmitted at a wavelength that is not visible to a human eye or night-vision assisted goggles for use in covert communication.

Another aspect of the present disclosure is a receiver for receiving optical communication in GPS-denied environments, comprising: an optical lens; an imaging sensor configured to receive an encoded optical signal comprising one or more frequencies transmitted by at least one light source, the imaging sensor comprising a plurality of pixels configured to provide asynchronous detection among the plurality of pixels for only those pixels having brightness changes in a field of view; a memory configured to store the optical signal; and a processor configured to process the pixels that detect brightness changes and to extract the one or more frequencies from the optical signal, to reconstruct a waveform for each of the one or more frequencies extracted from the optical signal, and to decode the optical signal.

One embodiment of the receiver is wherein the imaging sensor is configured to decode the optical signal using pulse position modulation or pulse width modulation. In certain embodiments, the optical signal is transmitted at a wavelength in the range of 1.55 μm to 1.7 μm for use in covert communication.

Another embodiment of the receiver is wherein the processor is configured to use the optical signal to perform tracking of the light source. In some cases, the use of the imaging sensor comprises a dynamic vision sensor or a neuromorphic sensor which decreases an overall data rate and allows for larger pixel arrays, thereby decreasing accuracy requirements of pointing hardware. In certain embodiments, the dynamic vision sensor comprises a read out integrated circuit (ROIC) combined with a photosensitive material.

Yet another aspect of the present disclosure is a method of processing optical signals in GPS-denied environments comprising: receiving an encoded optical signal comprising one or more frequencies at an imaging sensor of an event camera, the optical signal transmitted by at least one light source; extracting the one or more frequencies from the optical signal via an imaging sensor comprising a plurality of pixels configured to provide asynchronous detection among the plurality of pixels for only those pixels having brightness changes in a field of view, each of the one or more extracted frequencies corresponding to one or more events detected by the event camera; reconstructing one or more waveforms for each of the one or more extracted frequencies, and decoding the optical signal for use in covert communication.

One embodiment of the method further comprises decoding the optical signal using pulse position modulation or pulse width modulation.

Another embodiment of the method further comprises tracking a position of the light source as it moves within a field of view of the imaging sensor.

Yet another embodiment of the method further comprises overlaying event data from a complementary metal-oxide-semiconductor (CMOS) circuit onto the one or more waveforms.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a block diagram of one embodiment of a system and method for using event camera image sensors for optical communications including a transmitter and a receiver, where the receiver uses an event camera imaging sensor (e.g., a dynamic vision sensor), according to the present disclosure.

FIG. 2 is a graphical diagram showing an image and various frequencies extracted from the image, according to one embodiment of a system and method for using event camera image sensors for optical communications of the present disclosure.

FIG. 3A is a diagram of a field of view of an imaging sensor of the receiver, showing the CMOS array output for a single light source moving within the field of view, according to one embodiment of a system and method for using event camera image sensors for optical communications of the present disclosure.

FIG. 3B is a diagram of a field of view of an imaging sensor of the receiver, showing the CMOS array output for a plurality of light sources moving within the field of view, according to another embodiment of a system and method for using event camera image sensors for optical communications of the present disclosure.

FIG. 3C is a graph illustrating the detected events of FIG. 3A shown mapped out over time, according to the present disclosure.

FIG. 3D is a graph illustrating the detected events of FIG. 3B shown mapped out over time, according to the present disclosure.

FIG. 4A is a diagram of a field of view of an imaging sensor of the receiver, showing the CMOS array output for a plurality of different frequency light sources shown within the field of view, according to one embodiment of a system and method for using event camera image sensors for optical communications of the present disclosure.

FIG. 4B is a graph showing the detected event frequencies corresponding to the light sources of FIG. 4A, according to the present disclosure.

FIGS. 5A-FIG. 5D illustrate graphical diagrams of example waveforms reconstructed for each detected event frequency from FIG. 4B, with the reconstructed waveforms high-to-low transition corresponding to a light source getting dimmer and a low-to-high transition corresponding to the light source getting brighter, according to the present disclosure.

FIG. 6 is a flowchart of one embodiment of a method according to the principles of the present disclosure.

### DETAILED DESCRIPTION OF THE DISCLOSURE

An event camera is a device having an imaging sensor that operates differently than a traditional shutter-style or digital camera. A digital camera such as a high-speed framing camera requires a very high frame rate in order to act as a communications link, thus requiring a high bandwidth. Advantageously, in contrast, an event camera imaging sensor has a filter that detects changes directly on-chip. Thus, only pixels that are changing (getting brighter or dimmer) are output. This significantly reduces bandwidth requirements. Each transition of each changing pixel can be used for optical communications.

In certain embodiments, the event camera imaging sensor detects brightness changes directly on the sensor without requiring external processing. The event camera imaging sensor may also be referred to as a dynamic vision sensor (DVS) or a neuromorphic sensor. A “neuromorphic sensor” as used herein refers to an electrical circuit representation for a human biological/physiological function. The neuromorphic sensor operates much as the human retina does, and the terms “DVS” and neuromorphic sensor are generally interchangeable as used herein. Because the event camera imaging sensor only outputs a value when a particular pixel gets brighter (i.e., goes from “off” to “on”) or gets dimmer (i.e., goes from “on” to “off”), only pixels that are changing value are stored, along with their timestamp in memory. Thus, each pixel operates asynchronous to each other and outputs events rather than a full frame of intensity. The brighter and dimmer transitions can be used to reconstruct a waveform where each transition is either a high (1) or low (0) value which can be used to generate a signal representation of the optical signal for use for communication purposes. In some embodiments, the particular frequency for each optical signal within a field of view of the sensor can be extracted such that only waveforms for a particular predetermined frequency (or for multiple predetermined frequencies) are reconstructed. Further, once a particular light source of a particular frequency is identified within the field of view of the sensor, it can be tracked, as will be appreciated in light of the present disclosure.

In certain embodiments, the asynchronous nature of DVS mitigates the need to synchronize the transmitter and the receiver, particularly in a GPS-denied environment. One reason why this is so important, is that using prior (e.g., Geiger) technology required a need to know when the camera triggered with respect to when the pulse was sent because it is a time of flight measurement device. Here, in a GPS-denied environment, each pixel in a DVS is asynchronous in nature, and thus does not need to be time-synced to the transmitter. It only needs to maintain its own time and the transmitter can be on its own time source.

In a synchronous system, the start of a trigger (beginning of frame) must be known because a synchronous array is measuring the time from the start of the trigger until it receives energy (e.g. from a light source). It then computes the “time of flight” between the trigger (when light was sent) and when the pixel received energy. In order for that system to determine the actual time of flight, one must correlate the time of flight output from the camera (which is just a digital number) to a real time which is usually done based on internal clocks within the camera. Furthermore, in a communications system, it is most likely the case that the transmitter and the receiver are not co-located such that the transmitter can provide that start of trigger pulse to the camera. Therefore, both the transmitter and the camera must stay in-sync with each other, so the camera knows when the laser pulse (or beacon) was sent to compute that time (by means of a common time reference). Since the DVS array is asynchronous and does not care about the time of flight for light to reach the detector from the transmitter, it is only seeing changes and is not working off of a fixed synchronous time base. Furthermore, because it is only seeing changes in pixels rather than reading out every pixel, it considerably cuts down on the necessary bandwidth for the system.

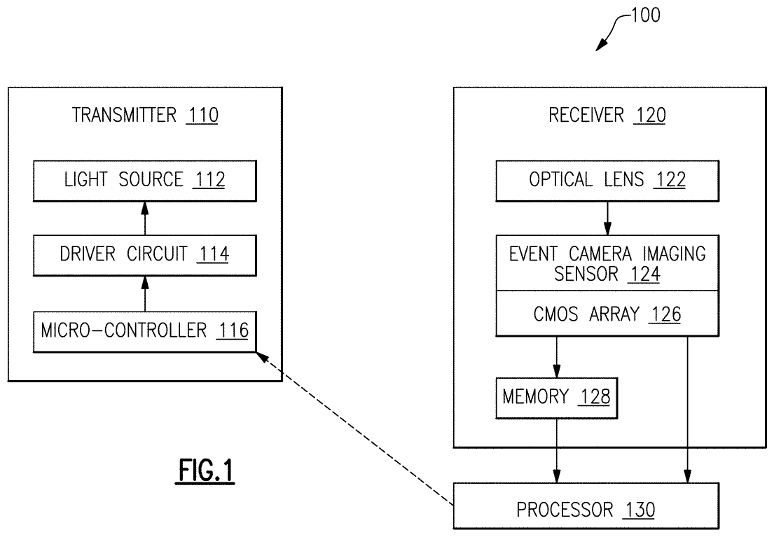

Reference is now made to FIG. 1 illustrating a block diagram of one embodiment of a system and method for using event camera image sensors for optical communications including a system 100 including a transmitter 110, a receiver 120, and a processor 130. The receiver 120 uses an event camera imaging sensor 124 (e.g., a dynamic vision sensor) for receiving and decoding optical communications, according to the present disclosure.

The transmitter 110 includes a light source 112 and a driver circuit 114 for driving the light source 112 under control of a micro-controller 116, or the like. The light source 112 can be a light emitting diode (LED) or any other appropriate light source. The light source 112 can be configured to transmit an optical signal at a specific predetermined frequency for optical communication purposes under control of the micro-controller 116 providing instructions to the driver circuit 114. The driver circuit 114 can be configured to encode the optical signal by pulse position modulation or pulse width modulation or any other appropriate frequency-modulated encoding scheme for an optical signal.

In certain embodiments, the driver circuit 114 is configured to transmit the optical signal at a frequency that is not visible to a human eye or human eye-assisted device, to thereby render the system covert and undetectable. As an example, the optical signal can be transmitted at a discrete wavelength in the range of 1.55 ρto 1.7 μm. By using standard encoding techniques at discrete wavelengths of light (e.g., 1.55 μm or 1.7 μm) the system 100 enables a low probability of detect/low probability of intercept (LPI/LPD) communications link. This system also allows frequency-modulated messages to be transmitted optically.

Still referring to FIG. 1, the receiver 120 may include an optical lens 122, an event camera imaging sensor 124, a CMOS array 126, and a memory 126. The imaging sensor 124 and the CMOS array 126 are configured to receive the optical signal. The imaging sensor 124 can be configured to decode the optical signal, and can be an event camera imaging sensor, such as a dynamic vision sensor (DVS) or neuromorphic sensor. The DVS type event camera imaging sensor can be a read out integrated circuit (ROIC) combined with a photosensitive material. Typically, for visible sensors, this material is Silicon. However, it would be advantageous, particularly for communications links, to use an alternate material that operates at higher wavelengths into the infrared band so that it is not visible, and thus not detectable or at least less detectable than signals in the visible spectrum. Specifically, for example, using a material such as Indium Gallium Arsenide (InGaAs) which is sensitive to “light” out to 1.7 μm could be paired with transmitters that work at 1.57 μm which is a common transmitter wavelength for the telecommunications industry. This would not be visible to the human eye or human eye assisted (or night vision) goggles. This further supports working at a longer distance because the wavelengths are higher and are beyond the capabilities of the human eye and thus may be used for covert communication. It is to be understood that other wavelengths are applicable to the principles of the present disclosure.

In certain embodiments, the transmitter is pulsed at rates that will keep the average power low, but also be within the bandwidth of the DVS camera. The communications link is agnostic to the type of transmitter, but specific to the type of receiver. The receiving system is configured to utilize the event capability of the DVS, as will be appreciated in light of the present disclosure.

The system further includes a processor 130 which may be remote from the receiver 120, as shown, or integrated into the receiver 120. In some embodiments, the transmitter 110 and the receiver 120 may each include their own respective processor. In one embodiment, the processor 130 is coupled to the receiver 120 (whether remote from or integrated into the receiver) and is configured to extract one or more frequencies from the optical signal to reconstruct a waveform for each frequency extracted from the optical signal. The processor 130 can further be configured to use the optical signal to perform object tracking of the light source within a field of view of the imaging sensor.

The processor 130 can further be configured to overlay CMOS data with the DVS data, or otherwise combine the outputs. In some instances, the DVS data from the imaging sensor 124 and the CMOS data from the CMOS array 126 can be stored in memory 128. In some instances, the DVS data from the imaging sensor 124 and the CMOS data from the CMOS array 126 can be sent directly to the processor 130, as shown in the dotted-line arrow. By integrating the DVS data with the traditional active pixel sensor CMOS arrays, this provides both DVS event outputs and monochrome framing outputs within the same sensor. It should be appreciated that the DVS events do not need to be used in conjunction with the CMOS output, and could be used independently. The CMOS output helps to provide context of the imaging field of view. The CMOS output and DVS events can be interleaved by the processor 130, such as directly overlaying DVS events onto a CMOS image, for example.

Using an event camera imaging sensor as the decoder allows the frequency of a periodic pulse to be extracted, and then a message can be encoded using that frequency. Moreover, event camera imaging sensors are much less expensive as compared to other optical-based communication systems. The DVS hardware itself can be produced commercially at a lower cost than other types of optical receivers, such as a traditional Geiger mode APD camera or a digital ROIC camera, for example.

The system 100 is applicable to a variety of uses, including air-to-ground optical communications, as well as ground-to-ground, air-to-air optical communications. For example, an unmanned aerial vehicle (UAV) could transmit imagery down to a ground station, where the DVS camera would be at the ground station. In another example, a soldier on the ground could use a beacon or other light source to transmit a covert message, which would be received by the DVS camera on-board an aircraft. In yet another example, a combat vehicle could transmit information to other vehicles along a convoy to provide situational awareness. Another use for DVS would be in a “sense and avoid” (SAA) application to be able to quickly detect (with low latency) objects moving for collision avoidance or for counter-unmanned aerial systems (c-UAS) detection. The DVS camera can also be used as a moving object detector for cueing large airborne wide-area (>60° field of view) imaging systems with high resolution (<1 m) to perform target tracking, as will be appreciated in light of the present disclosure.

FIG. 2 a graphical diagram 200 showing an image 210 and various frequencies 220 extracted from the image, according to one embodiment of a system and method for using event camera image sensors for optical communications of the present disclosure. The image 210, which for example may be acquired from a CMOS pixel array that captures the entire image, includes optical signals at various wavelengths. Each optical signal has a frequency as shown. This frequency can be extrapolated so that the event location (as shown on the x-axis and y-axis) can be plotted out over time (as shown on the z-axis). By extracting and identifying particular frequencies within the field of view shown in the image 210, a specific frequency can be identified and a waveform of the activity related to that specific frequency (i.e., becoming brighter or dimmer) can be reconstructed for the purposes of optical communications. As visible in the figure, only pixels containing information are being evaluated.

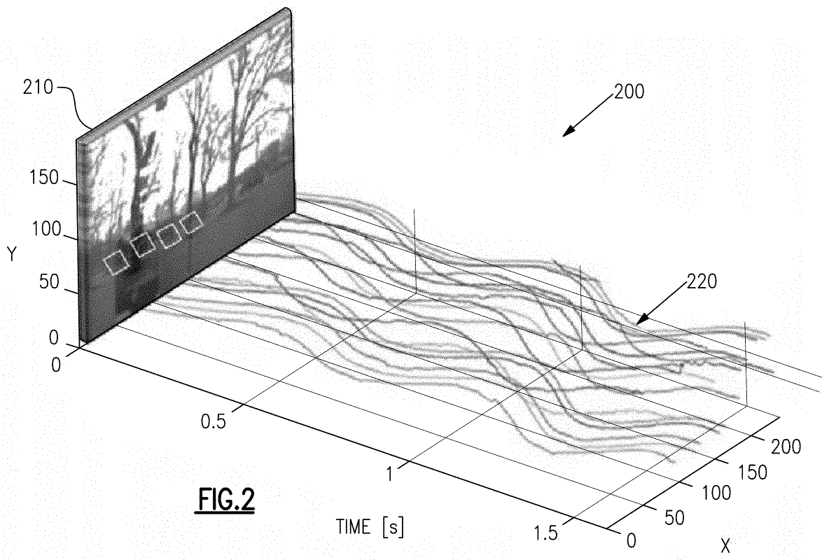

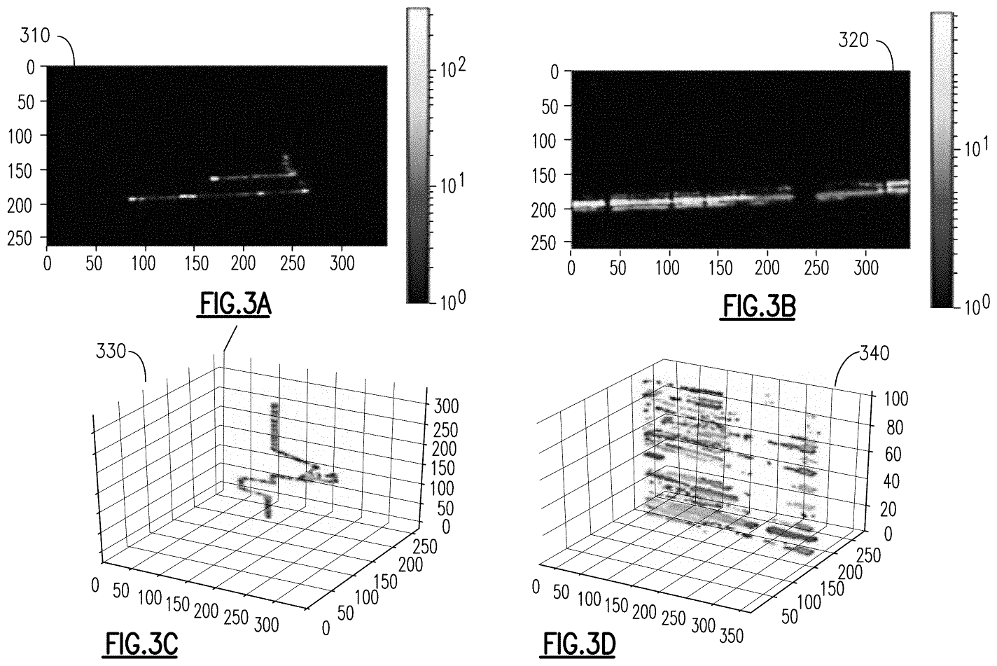

FIG. 3A is a diagram 310 of a field of view of an imaging sensor of the receiver, showing the CMOS array output for a single light source moving within the field of view of the sensor, according to the present disclosure. A plurality of detected events is shown in the diagram 310. In this example, a single light source operating at a single frequency is within the diagram 310 of the field of view shown in the image and producing the detected events. The position of the light source within the field of view shown in the image can be mapped over time, as shown in FIG. 3C. By utilizing specific-bandwidth transmitters and receivers, a DVS sensor, for example, can be used to receive an optical signal even when there is a plurality of changing light sources within the field of view. As will be appreciated, the position of the light source within the field of view can further be tracked for tracking purposes or collision avoidance.

FIG. 3B is a diagram 320 of a field of view of an imaging sensor of the receiver, showing the CMOS array output for a plurality of light sources moving within the field of view of the sensor, according to the present disclosure. A plurality of detected events for a plurality of different light sources are shown in the diagram 320 where each is transmitting at a different wavelength and is captured within the field of view shown in the image. The plurality of light sources, for example, could be the lights from moving traffic. The position of one or more of the light sources within the field of view can be mapped over time, as shown in FIG. 3D.

FIG. 3C is a graph 330 illustrating the detected events of FIG. 3A shown mapped out over time, according to the present disclosure. In the graph, the x-axis and y-axis values represent the event location within the field of view, and the z-axis value represents the time (in seconds). By mapping a specific frequency out over time, a waveform can be reconstructed for optical communications purposes. If this system were not stylizing a DVS, or the like, the entire cube (e.g., FIG. 3C and FIG. 3D) would be completely filled in since all pixels would produce an output (even if there is no scene change). In those figures, the X, Y is the array, and the vertical Z axis is time. The DVS array automatically sparsifies the cube into only the changes such that the required data bandwidth is a reduction of bandwidth as compared to prior systems approximated by those changing pixels (colored dots to non-colored dots). Furthermore, instead of outputting intensity which is usually 12-bits or higher, only the event (TRUE or FALSE) is output as a 1-bit identifier along with time.

FIG. 3D is a graph 340 illustrating the detected events of FIG. 3B shown mapped out over time, according to the present disclosure. In the graph, the x-axis and y-axis values represent the event location within the field of view, and the z-axis value represents the time (in seconds). One frequency could be detected within the field of view easily even when multiple other light sources are present, for example, or a specific bandwidth could be used for transmitting and receiving. In one embodiment, the light source can transmit the optical signal at a wavelength that is invisible to the human eye, such as 1.55 μm or 1.7 μm. Then, by extracting specific frequencies, the pixel transitions (high-to-low or low-to-high) can be used to reconstruct a waveform for a specific predetermined frequency identified within in field of view of the sensor. Thus, a transmitter including the light source and a receiver including the DVS sensor, or the like, can be used for covert optical communications.

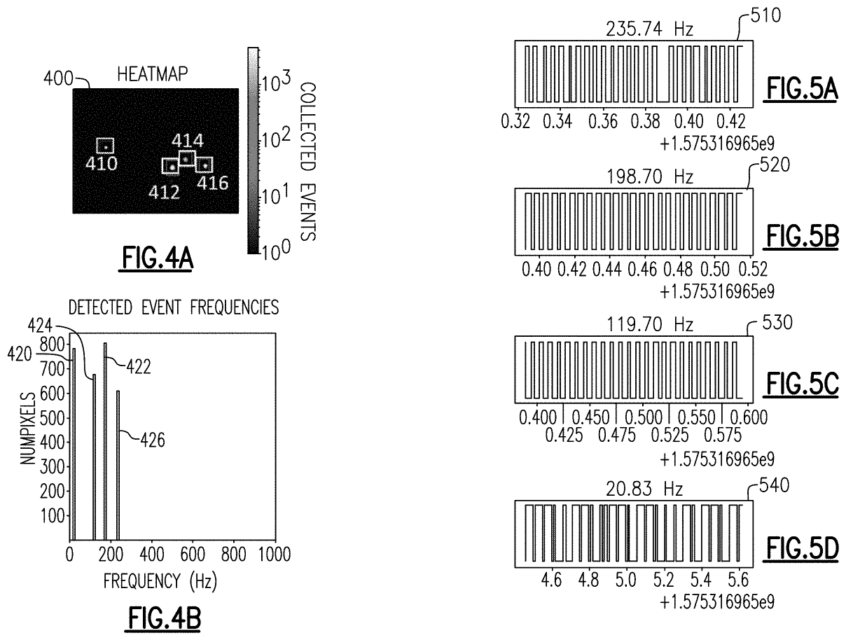

FIG. 4A is a diagram 400 of a field of view of an imaging sensor of the receiver, showing the CMOS array output for a plurality of different light sources having different frequencies shown within the field of view shown in the image, according to the present disclosure. As shown in the diagram 400, there are at least four detected events 410, 412, 414, and 416. Each detected event has a corresponding frequency, which can be extracted, as shown in the graph of FIG. 4B. In this example, each detected event 410, 412, 414, and 416 has a distinct frequency. FIG. 4B is a graph showing the detected event frequencies corresponding to the plurality of light sources of FIG. 4A, according to the present disclosure. Note that in this example, the detected event 410 corresponds to frequency 420 which has a value of approximately 119.70 Hz; the detected event 412 corresponds to frequency 422 which has a value of approximately 198.70 Hz; the detected event 414 corresponds to frequency 424 which has a value of approximately 20.83 Hz; the detected event 416 corresponds to frequency 426 which has a value of approximately 235.74 Hz. Each received optical signal at each detected frequency can be evaluated and reconstructed as a waveform based on whether the detected event is a transition from low-to-high (the light source turning on or becoming brighter) or from high-to-low (the light source turning off or becoming dimmer). This greatly reduces the overall data rate for the system and allows for larger pixel arrays, thereby decreasing the accuracy requirements of pointing hardware because only pixels that are changing are evaluated.

Reference is now made to FIG. 5A-FIG. 5D illustrating graphical diagrams of example waveforms reconstructed for each detected event frequency from FIG. 4B, with the reconstructed waveforms high-to-low transition corresponding to a light source getting dimmer and a low-to-high transition corresponding to the light source getting brighter, according to the present disclosure. FIG. 5A illustrates graph 510 which corresponds to the optical signal of the detected event frequency 426. FIG. 5B illustrates graph 520 which corresponds to the optical signal of the detected event frequency 422. FIG. 5C illustrates graph 530 which corresponds to the optical signal of the detected event frequency 420. FIG. 5D illustrates graph 540 which corresponds to the optical signal of the detected event frequency 424.

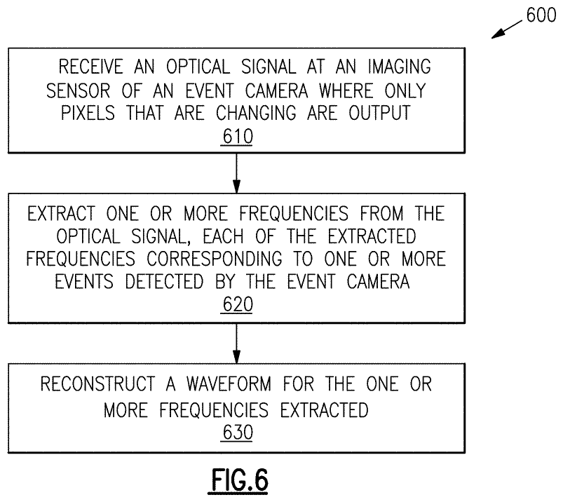

FIG. 6 is a flowchart of one embodiment of a method 600 according to the principles of the present disclosure. The method 600 commences at block 610 by receiving an optical signal at an imaging sensor of an event camera. The event camera imaging sensor can, for example, be imaging sensor 124 shown in FIG. 1 or another appropriate event camera imaging sensor. At block 620, one or more frequencies are extracted from the optical signal, each of the one or more extracted frequencies corresponding to one or more events detected by the event camera imaging sensor. As events are sent from the event camera imaging sensor (e.g., a DVS sensor), the events are processed as “dark-to-light” or “light-to-dark” transitions. The total intensity change does not need to be known, only that a change exists. This information is used along with a timestamp in order to reconstruct a waveform at block 630 where the vertical axis represents the transition type and the horizontal axis represents time (see, for example, graphs 510, 520, 530, and 540 shown in FIGS. 5A, 5B, 5C, and 5D, respectively). At block 630, a waveform is reconstructed for the one or more frequencies extracted from the optical signal. Once a waveform is detected, for example by applying a simple filter, pixels are grouped together that are behaving similarly and then the waveform is computed/reconstructed as described herein. One could further track the signal, e.g. communications link, as it moves within the field of view of the sensor to provide object or target tracking.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A system for transmitting optical communication in GPS-denied environments, comprising:
at least one transmitter comprising a light source driven by a driver circuit under control of a micro-controller to transmit an encoded optical signal comprising one or more frequencies;
a receiver comprising an optical lens, an imaging sensor comprising a plurality of pixels configured to receive the optical signal and provide asynchronous detection among the plurality of pixels for only those pixels having brightness changes in a field of view, and memory; and
a processor coupled to the receiver and configured to process the pixels that detect brightness changes and to extract the one or more frequencies from the optical signal, to reconstruct a waveform for each of the one or more frequencies extracted from the optical signal, and to decode the optical signal.

2. The system of claim 1, wherein the driver circuit is configured to encode the optical signal by pulse position modulation or pulse width modulation.

3. The system of claim 1, wherein the optical signal is transmitted at a wavelength in the range of 1.55 μm to 1.7 μm for use in covert communication.

4. The system of claim 1, wherein the processor is configured to use the optical signal to perform tracking of the light source.

5. The system of claim 1, wherein the processor is further configured to overlay data received from a complementary metal-oxide-semiconductor (CMOS) array of the receiver with dynamic vision sensor (DVS) data received from the imaging sensor.

6. The system of claim 1, wherein the light source is a light emitting diode (LED).

7. The system of claim 1, wherein the use of a dynamic vision sensor or a neuromorphic sensor decreases an overall data rate for the system and allows for larger pixel arrays, thereby decreasing accuracy requirements of pointing hardware.

8. The system of claim 7, wherein the dynamic vision sensor comprises a read out integrated circuit (ROIC) combined with a photosensitive material.

9. The system of claim 8, wherein the photosensitive material is Indium Gallium Arsenide (InGaAs).

10. The system of claim 1, wherein the optical signal is transmitted at a wavelength that is not visible to a human eye or night-vision assisted goggles for use in covert communication.

11. A receiver for receiving optical communication in GPS-denied environments, comprising:
an optical lens;
an imaging sensor configured to receive an encoded optical signal comprising one or more frequencies transmitted by at least one light source, the imaging sensor comprising a plurality of pixels configured to provide asynchronous detection among the plurality of pixels for only those pixels having brightness changes in a field of view;
a memory configured to store the optical signal; and
a processor configured to process the pixels that detect brightness changes and to extract the one or more frequencies from the optical signal, to reconstruct a waveform for each of the one or more frequencies extracted from the optical signal, and to decode the optical signal.

12. The receiver of claim 11, wherein the imaging sensor is configured to decode the optical signal using pulse position modulation or pulse width modulation.

13. The receiver of claim 11, wherein the processor is configured to use the optical signal to perform tracking of the light source.

14. The receiver of claim 11, wherein the use of the imaging sensor comprises a dynamic vision sensor or a neuromorphic sensor which decreases an overall data rate and allows for larger pixel arrays, thereby decreasing accuracy requirements of pointing hardware.

15. The receiver of claim 14, wherein the dynamic vision sensor comprises a read out integrated circuit (ROTC) combined with a photosensitive material.

16. The receiver of claim 11, wherein the optical signal is transmitted at a wavelength in the range of 1.55 μm to 1.7 μm for use in covert communication.

17. A method of processing optical signals in GPS-denied environments comprising:
receiving an encoded optical signal comprising one or more frequencies at an imaging sensor of an event camera, the optical signal transmitted by at least one light source;
extracting the one or more frequencies from the optical signal via an imaging sensor comprising a plurality of pixels configured to provide asynchronous detection among the plurality of pixels for only those pixels having brightness changes in a field of view, each of the one or more extracted frequencies corresponding to one or more events detected by the event camera;
reconstructing one or more waveforms for each of the one or more extracted frequencies, and
decoding the optical signal for use in covert communication.

18. The method of claim 17, further comprising:
decoding the optical signal using pulse position modulation or pulse width modulation.

19. The method of claim 17, further comprising:
tracking a position of the light source as it moves within a field of view of the imaging sensor.

20. The method of claim 17, further comprising:
overlaying event data from a complementary metal-oxide-semiconductor (CMOS) circuit onto the one or more waveforms.
